(19) United States
(12) Patent Application Publication
(10) Pub. No.: US 2015/0118481 A1
(43) Pub. Date: Apr. 30, 2015

(54) RESIN FOAM AND FOAM MATERIAL

(71) Applicant: NITTO DENKO CORPORATION, Ibaraki-shi, Osaka (JP)

(72) Inventors: Kiyoaki Kodama, Ibaraki-shi (JP); Makoto Saitou, Ibaraki-shi (JP); Itsuhiro Hatanaka, Ibaraki-shi (JP); Kazumichi Kato, Ibaraki-shi (JP)

(73) Assignee: NITTO DENKO CORPORATION, Ibaraki-shi, Osaka (JP)

(21) Appl. No.: 14/403,370

(22) PCT Filed: Jun. 5, 2013
(86) PCT No.: PCT/JP2013/065557

§ 371 Date: Nov. 24, 2014

(30) Foreign Application Priority Data
Jun. 7, 2012 (JP) 2012-129934
Jun. 4, 2013 (JP) 2013-117520

(51) Int. Cl. C08J 9/12; C08J 9/00; C09J 7/02

(52) U.S. Cl. CPC C08J 9/122; C09J 7/0289; C08J 9/0061; C08J 2203/08; C08J 2323/16; C08J 2423/12; C09J 2433/00; C09J 2423/166; C09J 2423/106
USPC 428/317.3; 521/140

(57) ABSTRACT

The present invention has the object of providing a resin foam and a foam material that exhibits superior dust resistance characteristics in a dynamic environment at the same time as having excellent light shielding characteristics, and is a resin foam having a repulsive force during an 80% compression at 23 degrees C. of 0.1 to 5.0 N/cm², a surface coverage rate of a foam surface of at least 50%, and a thickness recovery rate as defined below of at least 50%, the thickness recovery rate is defined as the ratio to an initial thickness of the thickness one second after release of a compressed state that is obtained by releasing a compressed state after compressing resin foam for one minute to a thickness of 20% relative to the initial thickness.

### TECHNICAL FIELD

The present invention relates to a resin foam and a foam material.

### BACKGROUND ART

Typically, a sealing material for use in a liquid crystal display device such as a touch panel, mobile telephone or the like includes configurations such as an adhesive sheet, or a reflective member (reference is made to Patent Literature 1) that has a black light shielding layer (liquid crystal module side) and a silver or white reflective layer (back light side) disposed between a liquid crystal module unit and a back light unit relative to a display screen (reference is made to Patent Literature 1 or 2). The light shielding layer prevents leakage of light from the back light onto the side with the liquid crystal module, and therefore enhances visual recognition characteristics.

A gasket material in such liquid crystal display devices includes use of a resin foam.

In recent years, such liquid crystal display devices have been subject to increasingly frequent use in dynamic environments such as a vibration environment or impact load environment as a result of inclusion of multiple functions or high level functions. Therefore, there is a need for the high level functions, and in particular high dust resistance characteristics, to be enhanced in comparison with a conventionally used adhesive sheet or gasket material. Furthermore, there is a strong demand for high dust resistance characteristics in dynamic environments such as a vibration environment or impact load environment.

### PRIOR ART DOCUMENTS

### Patent Documents

[Patent Document 1] JPH11-149254A
[Patent Document 2] JP2005-213282A

### DISCLOSURE OF THE INVENTION

### Problem to be Solved

The present invention has the object of providing a resin foam and a foam material that exhibits superior dust resistance characteristics in a dynamic environment at the same time as having excellent light shielding characteristics.

### Means for Solving the Problem

The present inventions include inventions described below.

(1) A resin foam having

a repulsive force during an 80% compression at 23 degrees C. of 0.1 to 5.0 N/cm²,

a surface coverage rate of a foam surface of at least 50%, and

a thickness recovery rate as defined below of at least 50%,

the thickness recovery rate is defined as the ratio to an initial thickness of the thickness one second after release of a compressed state that is obtained by releasing a compressed state after compressing resin foam for one minute to a thickness of 20% relative to the initial thickness.

(2) The resin foam as described above, wherein the resin foam has an apparent density of from 0.01 to 0.20 g/cm³.

(3) The resin foam as described above, wherein

the resin that configures the resin is a thermoplastic resin.

(4) The resin form as described above that is obtained by pressure reduction process in relation to a thermoplastic resin composition impregnated high pressure gas.

(5) The resin foam as described above, wherein the gas is an inert gas.

(6) The resin foam as described above, wherein the inert gas is carbon dioxide or nitrogen.

(7) The resin foam as described above, wherein the gas is a gas in a supercritical state.

(8) A foamed material comprising the resin foam as described above.

(9) The foamed material as described above, comprising an adhesive layer disposed on one or both sides of the resin foam.

(10) The foamed material as described above, wherein the adhesive layer is formed from an acrylic adhesive.

(11) The foamed material as described above for use in relation to an electronic or electrical device.

### Effect of the Invention

According to the present invention, it is possible to provide a resin foam and a foam material that exhibits superior dust resistance characteristics in a dynamic environment at the same time as having excellent light shielding characteristics.

### BRIEF DESCRIPTION OF THE DRAWINGS

FIG. 1A is a plan view illustrating the shape of an evaluation sample that is used when evaluating the dynamic dust resistance characteristics of a resin foam.

FIG. 1B is an upper view illustrating an evaluation container for dynamic dust resistance characteristics evaluation that includes assembly of the evaluation sample.

FIG. 1C is a schematic sectional view along the line A-A′ in FIG. 1B.

FIG. 2 is a schematic view illustrating a drum-type drop test device into which the evaluation container is placed.

### DESCRIPTION OF EMBODIMENTS

The resin foam of the present invention is foam that includes a resin, and is obtained by causing foaming or by molding of a resin composition. There is no particular limitation in relation to the shape of the resin foam of the present invention, and for example includes an agglomerated configuration, sheet configuration, film configuration, or the like.

Properties of Resin Foam

The repulsive force during an 80% compression at 23 degrees C. as defined below of the resin foam of the present invention is 0.1 to 5.0 N/cm², preferably 1.0 to 5.0 N/cm², more preferably 1.5 to 5.0 N/cm², and still more preferably 2.0 to 5.0 N/cm².

The repulsive force during an 80% compression is defined as the repulsive load during compression of the resin foam to an 80% thickness relative to the original thickness at 23 degrees C.

Superior flexibility and cushioning characteristics can be brought out when the resin foam of the present invention has a repulsive force during an 80% compression that falls within the above range. Thus, in particular, when the resin foam is used as a foam material, tracking characteristics in relation to micro-clearances can be brought out. As a result, even when there is a narrow clearance from the member to which it is applied, it is possible to effectively prevent the occurrence of failure (for example, deformation of the housing, member or the like in the periphery of the foam material, the occurrence of color shading in the image display unit, or the like) that is caused by the repulsion of the foam material.

The resin foam of the present invention exhibits a surface coverage rate for the foam surface of at least 50%, preferably at least 60%, more preferably at least 65%, and still more preferably at least 70%.

As used herein, the term “surface coverage rate (%)” means a value expressed by Formula (I) below.

Surface coverage rate (%)=([(surface area)−(surface area of holes in surface)]/surface area)×100 (1)

It is sufficient if at least the uppermost surface of the resin foam of the present invention satisfies the above surface coverage rate, or sufficient if the entire configuration of the resin foam in the film thickness direction can not satisfies the above surface coverage rate. Examples include a configuration in which the above surface coverage rate is satisfied in a surface layer having a depth of within about 20% of the whole film thickness of the resin foam, preferably within about 16%, more preferably within about 14%, and specifically within about 250 micrometers from the resin foam surface, preferably within about 150 micrometers, more preferably within about 100 micrometers, still more preferably within about 30 micrometers or about 20 micrometers.

The surface layer or the surface of the resin foam that has the above surface coverage rate is different from the configuration of a normal resin foam itself, and includes a structure in which air bubbles are ruptured and exhibit a non-uniform dense structure.

The resin foam of the present invention, as described below, is preferably formed by the same material in the thickness direction, including surface or the surface layer, and more preferably is integrally formed in the thickness direction of the resin foam. In this manner, it is possible to avoid a complex fabrication such as a lamination having layers of different materials, and prevent peeling on an interface between such layers.

For this purpose, for example as described below, after forming the resin foam, although a predetermined surface coverage rate can be imparted by heating and melting the surface, various conditions during that process can be varied to thereby enable adjustment of the surface coverage rate itself.

The above surface coverage rate imparts extremely preferred flexibility and cushioning characteristics as described above to the resin foam itself, and irrespective of the presence or absence of compression, also imparts superior light shielding characteristics to thereby effectively prevent light leakage of a display device of a mobile telephone or mobile information terminal, or the like and therefore enhances visual recognition characteristics of the screen. The resin foam of the present invention exhibits light shielding characteristics not only when used under compression but also when used without compression, and therefore transmittance of light at a wavelength of 550 nm is no more than 0.08, preferably no more than 0.05, more preferably no more than 0.01.

A feature exhibiting a high surface coverage rate means, in other words, that the surface of the resin foam exhibits air tight characteristics. Therefore, superior sound insulating characteristics can be ensured without leakage to the outside of vibration or sound produced on the inside. Furthermore, when using the resin foam as a sealing material or the like for a mobile telephone, a mobile information terminal or the like, water resistance can also be imparted since sealing characteristics on the interface between the resin foam surface and such devices can be maintained. In particular, such functions, when imparted extremely preferred flexibility and cushioning characteristics, can effectively bring out since sealing characteristics and air tight characteristics can be ensured even upon application of an impact such as a drop or vibration in a dynamic environment.

In addition, since a high surface coverage rate minimizes surface roughness in comparison to typically used resin foams, and thereby ensures flatness, adhesion or mounting is facilitated by the large contact surface area when mounting a resin foam on a flat member for example in an inner side of a housing or the like or a mobile telephone, mobile information terminal or the like, or when adhering an adhesive tape, such as a double sided tape to be mounted on a member such as the housing of such devices, to the resin foam.

The resin foam of the present invention exhibits a thickness recovery rate at 23 degrees C. as defined below of at least 50% (for example, 50 to 100%), preferably at least 65% (for example, 65 to 100%), more preferably at least 68% (for example, 68 to 100%) or at least 70% (for example, 70 to 100%), and still more preferably at least 75% (for example, 75 to 100%).

The thickness recovery rate is defined as the ratio to an initial thickness of the thickness one second after release of a compressed state, which is obtained by releasing a compressed state after compressing resin foam for one minute to a thickness of 20% relative to an initial thickness.

Since the resin foam of the present invention exhibits the thickness recovery rate of at least 50%, it possess excellent strain recovery characteristics. Therefore, the resin foam exhibits superior dust resistance characteristics, and in particular superior dynamic dust resistance characteristics (dust resistance characteristics under a dynamic environment). Furthermore, when a foamed material configured to include the resin foam of the present invention is applied to a clearance, if the foam material is deformed by an impact during a drop or a vibration, that is to say, even in a state in which the foam member is compressed and exhibits a thickness that is less than or equal to the applied clearance, the thickness rapidly recovers to a sufficient level to thereby cover the clearance and effectively prevent entry of foreign particles such as dust.

It is preferred that the resin foam of the present invention for example has a cell (air bubble) structure that includes a closed-cell structure or a semi-open semi-closed cell structure (a cell structure that is configured as a mixture of a closed-cell structure and an open-cell structure, and in which there is no particular limitation in relation to the proportion of their). In particular, a cell structure is included in which a closed-cell ratio of the resin foam is no more than 50%, preferably no more than 40% and more preferably no more than 35%. When in this range, sufficient impact absorption characteristics are exhibited due to loss of air from the resin during a compressive deformation such as during an impact. Furthermore, the cell structure includes a closed-cell ratio of the resin foam of at least 10%, preferably at least 15% and more preferably at least 20%. When in this range, the ratio of the open cells can be adjusted to thereby prevent passage of microscopic particles such as dust and therefore enhance the dust resistance characteristics.

The closed-cell ratio for example can be measured by a method as disclosed in the examples.

It is preferred that the resin foam of the present invention exhibits an apparent density of 0.01 to 0.20 g/cm³, more preferably 0.01 to 0.15 g/cm³, 0.01 to 0.10 g/cm³, and still more preferably 0.02 to 0.08 g/cm³.

When the apparent density falls within this range, sufficient strength is ensured, and superior processing characteristics (in particular, punching processing characteristics) can be imparted. At the same time, flexibility can be ensured and tracking characteristics in relation to micro-clearances when used as a foam material can be imparted.

The apparent density normally denotes the density of the resin foam at a position other than a layer that has the surface coverage rate described above due to the fact that the cell structure in that layer will be different. Furthermore, in the present invention, since the thickness of the layer that has the surface coverage rate described above is small relative to the entire thickness of the resin foam, when the apparent density is measured in relation to the entire thickness of the resin foam including that layer, it is confirmed that there is not a large change to the resulting value. Therefore, when the thickness of the layer that has the surface coverage rate falls within the above range, the density can include the layer that has the surface coverage rate above.

The resin foam of the present invention preferably exhibits an average cell diameter in the cell structure of 10 to 200 micrometers, 10 to 180 micrometers, more preferably 10 to 150 micrometers, still more preferably 10 to 90 micrometers, and further still more preferably 20 to 80 micrometers

The average cell structure can be calculated for example by use of a digital microscope (Trade name “VH-8000” or “VH-500” manufactured by Keyence Corporation) to obtain an enlarged image of the cell portion and then analyze that image by use of image analysis software (Trade name “Win ROOF” manufactured by Mitani Corporation).

Dust resistance characteristics are enhanced and light shielding characteristics are superior when the upper limit of the average cell diameter of the foam in the resin foam of the present invention is no more than 200 micrometers, preferably no more than 180 micrometers, no more than 150 micrometers, more preferably no more than 90 micrometers, and still more preferably no more than 80 micrometers. On the other hand, cushioning characteristics (impact absorption characteristics) can be enhanced when the lower limit of the average cell diameter of the foam in the resin foam is at least 10 micrometers, and preferably at least 20 micrometers.

In particular, when the resin foam of the present invention is configured to include all of the repulsive force during an 80% compression, the thickness recovery rate and the surface coverage ratio as described above, both dust resistance characteristics and light shielding characteristics can maintained with greater certainty in relation to an impact in a dynamic environment.

Material for Resin Foam

The resin foam of the present invention is formed of a resin, preferably a resin composition having a thermoplasticity resin.

Examples of the thermoplasticity resin include poly olefinic polymers such as low-density polyethylenes, medium-density polyethylenes, high-density polyethylenes, linear low-density polyethylenes, polypropylenes, copolymers between ethylene and propylene, copolymers between ethylene or propylene and another alpha-olefin (e.g., butane-1, pentene-1, hexane-1,4-methylpentene and the like) and copolymers between ethylene and another ethylenically unsaturated monomer (e.g., vinyl acetate, acrylic acid, an acrylic acid ester, methacrylic acid, a methacrylic acid ester, or vinyl alcohol); styrenic polymers such as polystyrenes and acrylonitrile-butadiene-styrene copolymers (ABS resins); polyamides such as 6-nylon, 66-nylon, and 12-nylon; polyamideimides; polyurethanes; polyimides; polyetherimides; acrylic resins such as polymethyl methacrylates; polyvinyl chlorides; polyvinyl fluorides; alkenyl aromatic resins; polyesters such as polyethylene terephthalates and polybutylene terephthalates; polycarbonates such as bisphenol-A polycarbonates; polyacetals; and polyphenylene sulfides.

The thermoplastic resin can be used alone or in combination. Any co-polymers such as random co-polymer or block co-polymer can be used if the thermoplastic resin is co-polymer.

The thermoplastic resin is preferably a polyolefin-based resin in view of characteristics such as mechanical strength, heat resistance characteristics, chemical resistance characteristics, and the like, and molding characteristics such as ease of molten thermal molding.

The polyolefin-based resin suitably includes a resin of type that exhibits a wide molecular weight distribution and a shoulder on the high molecular weight side, a weakly cross linked type resin (resin of a type that is slightly cross linked), a long chain branching type resin, or the like.

In particular, the polyolefin-based resin preferably includes a polyolefin-based resin that exhibits a melt tension (temperature: 210 degrees C., a rate of pulling: 2.0 m/min, capillary: a diameter of 1 mm×10 mm) of 3 to 50 cN (preferably, 8 to 50 cN).

The thermoplastic resin includes a rubber component and/or a thermoplastic elastomer component.

The glass transition temperature of the rubber component and the thermoplastic elastomer component for example is less than or equal to ambient temperature (for example, no more than 20 degrees C.) and therefore extremely excellent shape tracking characteristics and flexibility when configured as a resin foam are imparted.

There is no particular limitation in relation to the rubber component and the thermoplastic elastomer component if they have rubber elasticity and are foamable. Examples thereof include crude rubber or synthetic rubber such as polyisobutylene, polyisoprene, chloroprene, butyl rubber, nitrile butyl rubber; olefin elastomer such as ethylene-propylene copolymer, ethylene propylene diene copolymer, ethylene vinyl acetate copolymer, polybutene, and chlorinated polyethylene; styrene elastomer such as styrene butadiene styrene copolymer, styrene-isoprene-styrene copolymer and hydrogenated product thereof; polyester elastomer; polyamide elastomer; polyurethane elastomers and other various thermoplastic elastomers.

They can be used alone or in combination.

The rubber component and/or a thermoplastic elastomer component is preferably an olefin-based elastomer. The olefin-based elastomer is preferably compatible with the polyolefin-based resins that have been given as an example of a thermoplastic resin.

The olefin-based elastomer can be a type that exhibits a micro-phase separated structure in relation to a resin component A (olefin-based resin component A) and a rubber component B, can be a type in which the resin component A and the rubber component B are physically dispersed, or can be a type in which the resin component A and the rubber component B are dynamically and thermally processed in the presence of a cross linking agent (dynamically cross-linked thermoplastic elastomer, Thermoplastic Vulcanizates: TPV). Of these, configurations, the olefin-based elastomer is preferably a dynamically cross-linked thermoplastic olefin-based elastomer (TPV).

The dynamically cross-linked thermoplastic olefin-based elastomer exhibits a higher coefficient of elasticity and a smaller compression permanent deformation than TPO (non-cross linked thermoplastic olefin-based elastomer). In this manner, excellent recovery characteristics can be exhibited when configured as a resin foam.

As described above, the dynamically cross-linked thermoplastic olefin-based elastomer is obtained by subjecting a mixture including a resin component A that forms a matrix (olefin-based resin component A) and a rubber component B that forms a domain to a dynamic thermal process in the presence of a cross linking agent, and a multi-phase polymer having a sea/island structure in which the cross linked rubber particles are finely dispersed as a domain (island phase) in the resin component A that is a matrix (sea phase).

This type of dynamically cross-linked thermoplastic olefin-based elastomer includes ones described in JP2000-007858A, JP2006-052277A, JP2012-072306A, JP2012-057068A, JP2010-241897A, JP2009-067969A and JP2003/002654A, and commercially available elastomers such as Zeotherm™ produced by Zeon Corporation, THERMORUN™ produced by Mitsubishi Chemical Corporation, and SARLINK produced by TOYOBO Co., Ltd.

There is no particular limitation in relation to the content thereof when the resin that configures the resin foam of the present invention includes the rubber component and/or thermoplastic elastomer component along with a thermoplastic resin. For example, the weight ratio of the thermoplastic resin and the rubber component and/or thermoplastic elastomer component in the resin that configures the resin foam of the present invention is preferably 70/30 to 30/70, more preferably 60/40 to 30/70, still more preferably 50/50 to 30/70, and further still more preferably 60/40 to 10/90, 58/42 to 10/90 or 55/45 to 10/90. When the proportion of the rubber component and/or thermoplastic elastomer component is excessively low, the cushioning characteristics of the resin foam tend to be adversely affected or the recovery characteristics after compression are reduced. On the other hand, when excessively large, there is a tendency for gas leakage to occur during foam formation, and thereby cause difficulties in relation to obtaining a foam that exhibits high foaming characteristics.

Since the resin foam of the present invention exhibits flexibility during high compression and shape recovery after compression, that is to say, since a large deformation is enabled and plasticity deformation does not occur, using a material that exhibits excellent so-called rubber elasticity is suitable for the resin foam of the present invention. In the light of that, the resin foam of the present invention preferably includes the rubber component and/or thermoplastic elastomer component along with the above thermoplastic resin as a constituent resin composition.

The resin foam of the present invention preferably further includes a nucleating agent in the constituent resin composition. When a nucleating agent is included, simple adjustment of the cell diameter is enabled and foam can be obtained that exhibits excellent cutting process characteristics along with suitable flexibility.

Examples of the nucleating agent include oxides, complex oxides, metal carbonates, metal sulfates, metal hydroxide such as talc, silica, alumina, zeolite, calcium carbonate, magnesium carbonate, barium sulfate, zinc oxide, titanium oxide, aluminum hydroxide, magnesium hydroxide, mica, and montmorillonite; carbon particles; glass fibers; carbon tube, and the like. The nucleating agents are used alone or in a combination of two or more.

There is no particular limitation in relation to the average particle diameter of the nucleating agent, and the diameter is preferably 0.3 to 1.5 micrometers, and more preferably 0.4 to 1.2 micrometers. The average particle diameter in this manner enables sufficient functioning as a nucleating agent. Furthermore, the nucleating agent does not pierce the cell walls and thereby realizes a high foaming factor.

The average particle diameter can be measured by use of a laser-diffraction particle distribution measurement method. For example, dispersed diluents of a sample can be measured (in AUTO measurement mode) by use of “MICROTRAC MT-3000” manufactured by LEEDS AND NORTHRUP INSTRUMENTS.

There is no particular limitation in relation to the content of the nucleating agent, and the content is preferably from 0.5 to 150 parts by weight, more preferably from 2 to 140 parts by weight, and still more preferably 3 to 130 parts by weight to 100 parts by weight of the constituent resin.

When the resin foam of the present invention is configured by a thermoplastic resin, a flame retardant is preferably included due to the tendency for combustion.

The flame retardant is preferably an inorganic flame retardant that is non-halogen-non-antimony based.

The inorganic flame retardant for example includes a metal hydroxide, a hydrate of a metal compound, or the like. More specifically, it includes aluminum hydroxide; magnesium hydroxide; hydrates of magnesium oxide or nickel oxide; hydrates of zinc oxide and magnesium oxide; or the like. Of these, substances, magnesium hydroxide is preferred. The hydrated metal compounds can be surface-treated. The flame retardants are used alone or in a combination of two or more.

When the flame retardant is included in the resin foam of the present invention, the amount thereof is preferably from 5 to 70 parts by weight, and more preferably from 25 to 65 parts by weight to 100 parts by weight of the constituent resin.

The resin foam of the present invention further includes at least one aliphatic compound having a polar functional group and a melting point of 50 to 150 degrees C., and selected from the group comprising of a fatty acid, a fatty amide, and a fatty acid metal soap. Of these, substances, a fatty acid and a fatty amide are preferred.

When those types of aliphatic compounds are included in the resin foam of the present invention, the cell structure is resistant to collapse during processing (in particular punch processing), shape recovery characteristics are improved and processing characteristics (especially punch processing characteristics) are further enhanced. This effect assumed to be due to the fact that those types of aliphatic compounds exhibit high crystallinity, and form a solid film on the resin surface when added to a thermoplastic resin (in particular a polyolefin-based resin) to thereby have the effect that the wall faces of the cells that form the cell structure are prevented from blocking each other.

Those types of aliphatic compounds that include functional groups exhibiting high polarity have a tendency not to be compatible with, in particular, polyolefin-based resins, and therefore tend to be deposited on the resin foam surface and thereby exhibit the above effect.

In view of reducing the molding temperature during molding or foaming of the resin composition, inhibiting deterioration of the resin (in particular, a polyolefin-based resin) and of imparting sublimation resistance, the melting point of the aliphatic compound is preferably 50 to 150 degrees C., and more preferably 70 to 100 degrees C.

A fatty acid is a fatty acid preferably having about 18 to 38 carbon atoms, more preferably having about 18 to 22 carbon atoms. Examples of the fatty acid include stearic acid, behenic acid, 12-hydroxystearic acid. Of these, behenic acid is particularly preferred.

A fatty amide is a fatty amide preferably having about 18 to 38 carbon atoms, more preferably having about 18 to 22 carbon atoms. Such fatty amides can be either monoamides and bisamides. Examples of the fatty amide include stearamide, oleamide, erucamide, methylene bisstearamide, ethylene bisstearamide. Of these, erucamide is particularly preferred.

Examples of a fatty acid metallic soap include a salt such as aluminum, calcium, magnesium, lithium, barium, zinc, lead of the above fatty acid.

When the resin foam of the present invention includes the above aliphatic compounds, there is no particular limitation in relation to the content thereof, and a content of 1 to 5 parts by weight is preferred, 1.5 to 3.5 parts by weight are more preferred, and 2 to 3 parts by weight is still more preferred to 100 parts by weight of the constituent resin. In this manner, it is possible to maintain sufficient pressure during molding or foaming of the resin, the content of the foaming agent (for example, an inert gas such as carbon dioxide, nitrogen, or the like) can be maintained to thereby obtain a high expansion ratio.

The resin foam of the present invention can contain a lubricant. In this manner, the flow characteristics of the resin composition can be enhanced and it is possible to inhibit thermal deterioration of the resin. The lubricant can be used alone or in a combination of two or more.

There is no particular limitation in relation to the lubricants, and examples thereof include hydrocarbon lubricants such as liquid paraffins, paraffin waxes, microcrystalline waxes, and polyethylene waxes; ester lubricants such as butyl stearate, stearic acid monoglyceride, pentaerythritol tetrastearate, hydrogenated castor oil, and stearyl stearate.

The content of the lubricant can be suitably selected in a range that does not adversely affect the effect of the present invention.

The resin foam of the present invention can further contain one or more other additives according to necessity. Examples of such additives include shrinkage inhibitors, age inhibitors, thermostabilizer, light stabilizer such as HALS, weather resistance agents, metal deactivators, UV absorbers, light stabilizers, stablilizers such as a copper inhibitor, antibacterial agent, antifungal agent, dispersion agent, tackifier, colorant such as carbon black, organic pigments, fillers, and the like. When the TPV is used, the composition including thereof can contain additives such as a colorant, e.g., carbon black, and a softener. The additives can be used alone or in a combination of two or more.

The content of additives can be chosen within ranges not impeding of the effects of the present invention.

Method of Manufacture of Resin Foam

The resin foam of the present invention is manufactured by using a resin composition which is obtained by mixing and kneading or the like of a thermoplastic resin (including a rubber component and/or a thermoplastic elastomer component) and optionally including additives such as a nucleating agent, an aliphatic compound, a lubricant or the like, and by foaming or molding of the resin composition.

Foaming methods to be used when at foaming or forming the resin composition are not limited and include customary methods such as physical techniques and chemical techniques. An exemplary customary physical technique is a technique in which a low-boiling liquid (blowing agent), such as a chlorofluorocarbon or a hydrocarbon, is dispersed in a resin, and is heated to volatilize the blowing agent to thereby form cells. An exemplary customary chemical technique is a technique of adding a compound (blowing agent) to a resin, and thermally decomposing the blowing agent to form a gas to thereby form cells.

In the present invention, a method of using a high-pressure gas as the blowing agent is preferred to give a foam having a small cell diameter and a high cell density easily. In particular, a method of using a high-pressure inert gas as the blowing agent is preferred.

A method of using a high pressure gas as the foaming agent preferably includes a method in which after high pressure gas is impregnated into the resin composition, formation is performed by passing through a step of pressure reduction. More specifically, the method includes a method in which, after impregnating a high pressure gas in a non-foam or molded article that is formed from a resin composition, and the method passes through a pressure reduction step, and a method in which, after impregnating gas in a pressurized state into a molten resin composition, the method forms the object by molding and reducing pressure, or the like.

There is no particular limitation in relation to the inert gas, as long as being inert to the resin to be used as a material for the resin foam, and being impregnatable into the resin. Exemplary inert gases include carbon dioxide, nitrogen gas, and air. These gases can be used in combination as a mixture. Of these, carbon dioxide or nitrogen is preferred, because they can be impregnated in a large amount and at a high rate into the resin, and carbon dioxide is more preferred.

Further, from the stand point of the acceleration of impregnation into the resin, the above high pressure gas (such as an inert gas, in particular, carbon dioxide) is preferably in a supercritical state. When being in a supercritical state, it shows increased solubility in the resin and can thereby be incorporated in the resin in a higher concentration. In addition, because of its high concentration impregnation, the supercritical inert gas generates a larger number of cell nuclei upon an abrupt pressure drop after impregnation, and because the density of the cells which is formed by growing the cell nuclei is higher than in a foam having the same porosity, consequently, it can give fine cells. For example, carbon dioxide has a critical temperature of 31 degrees C. and a critical pressure of 7.4 MPa.

A method for foaming and molding the resin composition by use of a method that uses high pressure gas as a foaming agent includes a batch method in which, after a resin composition is molded into a suitable shape such as a sheet and configured as a non-foam resin molded body (non-foam resin molded article), high pressure gas is impregnated into the non-foam resin molded body and foaming is performed by release of pressure, and a continuous method in which a resin composition is kneaded with a high pressure gas under application of pressure, the pressure is released during molding, and molding and foaming are performed at the same time.

When molding or foaming a resin composition in a batch method, a method that forms a non-foam resin molded body for foaming includes, for example, a method in which a resin composition is molded using a kneading machine such as a single screw extruder, a twin screw extruder, and the like; a method in which a resin composition is uniformly kneaded using a kneading machine such as a roller, cam, kneader, a Banbury type blade or the like, and is pressed and molded to a predetermined thickness using a hot plate press; and a method that molds the resin composition by use of an injection molding machine, or the like.

In addition, the non-foam resin molded body can also formed by another molding method in addition to extrusion molding, press molding, or injection molding.

Furthermore, there is no particular limitation in relation to the shape of the non-foam resin molded body. Various shapes can be selected in response to a given use, and for example includes a sheet configuration, a roll configuration, a tabular configuration, an agglomerated configuration, or the like.

In this manner, when molding or foaming the resin composition in a batch method, it is possible to mold the resin composition using a suitable method to thereby obtain a non-foam resin molded body having a desired thickness and shape.

When molding or foaming the resin composition in a batch method, cells are formed in the resin by passing through a gas impregnation step of placing the resulting non-foam resin molded body in a pressure-resistant vessel (high-pressure vessel), introducing high pressure gas (such as an inert gas, in particular, carbon dioxide), and impregnating the high pressure gas into the non-foam resin molded body, and a pressure reduction step of releasing the pressure (usually to atmospheric pressure) when the high pressure gas is sufficient impregnated to cause the production of cell nuclei in the resin, and in some cases (when required), a heating step in which the cell nuclei are grown by heating. The cell nuclei can be grown at ambient temperature in the event that a heating step is not provided.

When molding or foaming the resin composition in a continuous method, foaming or molding is performed by a kneading and impregnation step in which the resin composition is kneaded by use of extruding device such as a single screw extruder or double screw extruder, high pressure gas (such as an inert gas, in particular, carbon dioxide) is introduced, and the high pressure gas is fully impregnated into the resin composition, and a molding and pressure reduction step in which the pressure is released (usually to atmospheric pressure) by extruding the resin composition through a die or the like provided on the distal end of the extruder and performing molding and foaming at the same time.

In the kneading and impregnation step and the molding and pressure reduction step, use of an injection molding device is possible other than use of an extruding device. Furthermore, when foaming or molding the resin composition in a continuous method, a heating step can be provided as required in order to grow the cells by heating.

When using either the continuous method or batch method, after growing cells, rapid cooling can be performed by application of cold water as required, to thereby solidify a shape. Furthermore, the introduction of high pressure gas can be performed continuously or discontinuously.

A method of heating when growing the cell nuclei includes application of a known method such as a water bath, oil bath, heated roller, heated air oven, far infrared, near infrared, microwave, or the like.

There is no particular limitation to the mixing amount of gas when foaming or molding the resin composition, and for example, is preferably 2 to 10 parts by weight relative to the total amount of the resin component in the resin composition, and more preferably is 2.5 to 8 parts by weight, and still more preferably 3 to 6 parts by weight. When in that range, foam with a high expansion rate can be obtained without separation of the gas in the molding device.

When manufacturing the resin foam of the present invention, it is preferred to perform stretching during the above steps or after performing the above steps in order to produce a stable foam in an efficient manner.

The stretching operation is preferably performed so that the ratio of the extrusion speed and the molding speed of the resin is 1:1.2 to 5.

When the stretching operation falls within the above range, it is possible to prevent instability in feeding of the resin sheet by reason of the frictional resistance of the roll or belt, and thereby avoid crushing the thickness direction as a result of excess stretching. As a result, it is possible to ensure porosity, cushioning characteristics, and flexibility.

When the resin contains a large amount of the rubber component and/or thermoplastic elastomer component, although it is normally the case that sliding with respect to the belt or roll decreases, when the stretching falls within the above range, stable feeding of the sheet is enabled irrespective of the resin composition, and it is possible to obtain a resin foam with a stable shape.

As used herein, molding speed denotes the speed of feeding the resin sheet by the belt or roll. There is no particular limitation on the molding speed, and for example is preferably 2 to 100 m/min. In this manner, stable molding of the resin sheet is enabled and thereby production efficiency can be maintained.

Furthermore, when the resin sheet is nipped by means of a belt or roll, the nip pressure is preferably of a degree that does not cause the foam to collapse in the thickness direction.

The pressure when impregnating gas into the non-foam molded body or the resin composition, in the gas impregnation step in a batch method, and in the kneading and impregnation step in a continuous method during foaming and molding the resin composition in relation to the resin foam of the present invention is suitably selected in consideration of the type of gas or operation characteristics. For example, when the gas is an inert gas, and in particular when it is carbon dioxide, the pressure is at least 6 MPa (for example 6 to 100 MPa), preferably at least 8 MPa (for example 8 to 100 MPa).

When the pressure has the above setting, the impregnated gas content coincides with a suitable amount, the cell nuclei formation speed can be controlled and the number of formed cell nuclei can be adjusted to a suitable number. Furthermore, the cell growth during foaming can be suitably controlled and it is possible to adjust the cell diameter to a small value. That is to say, control of the cell density and the cell diameter is facilitated. As a result, a superior dust resistance effect can be imparted.

The temperature when impregnating high pressure gas into the non-foam molded resin body or the resin composition in the gas impregnation step in a batch method, and in the kneading and impregnation step in a continuous method during foaming and molding the resin composition can be suitably adjusted in response to the type of gas or resin that is used. For example, when operation characteristics are taken into account, the temperature is 10 to 350 degrees C.

More specifically, in a batch method, the impregnation temperature when high pressure gas is impregnated into a non-foam molded resin body that is in the shape of a sheet is preferably 10 to 250 degrees C., more preferably 40 to 240 degrees C., and still more preferably 60 to 230 degrees C.

In a continuous method, the impregnation temperature when high pressure gas is introduced and kneaded into the resin composition is preferably 60 to 350 degrees C., more preferably 100 to 320 degrees C., and still more preferably 150 to 300 degrees C.

When carbon dioxide is used as the high-pressure gas, the impregnation temperature is preferably at least 32 degrees C., and more preferably at least 40 degree C. in order to keep carbon oxide in a supercritical state.

The decompression in the decompression step in a batch method or in a continuous method during foaming and molding the resin composition is preferably performed at a decompression speed of 5 to 300 MPa/second, for obtaining more uniform fine cells.

The heating in the heating step can be performed at a temperature of typically from 40 to 250 degrees C., and preferably from 60 to 250 degree s C.

When using the above method during foaming or molding of the resin composition, a highly-foamed resin foam can be manufactured and it is possible to manufacture a thick resin foam.

For example, when foaming or molding the resin composition in a continuous method, in order to maintain pressure in the extrusion machine during the kneading and impregnation step, it is required to minimize any gap in the die mounted on the distal end of the extrusion machine (normally of about 0.1 to 1.0 mm). Therefore, the resin composition that is extruded through such a narrow gap is caused to foam with a high foaming ratio in order to obtain a thick resin foam.

Typically, the thickness of the resulting resin foam has been limited to thin configurations (for example, 0.5 to 2.0 mm) since a high foaming ratio could not be obtained. In this regard, foaming or molding of the resin composition using high pressure gas enables continuous formation of a resin foam having a final thickness of 0.50 to 5.00 mm.

The resin foam of the present invention enables adjustment of the repulsive force under an 80% compression, the thickness recovery rate, the apparent density, the relative density, the average cell diameter, or the like by suitably selecting and setting, for example, operational conditions such as temperature, pressure, time or the like during the gas impregnation step or kneading and impregnation step, operational conditions such as pressure reduction rate, temperature, pressure, or the like during the pressure reduction step or molding and pressure reduction step, or the heating temperature in a heating step after pressure reduction or molding and pressure reduction according to the types of gas, thermoplastic resin, rubber component and/or thermoplastic elastomer component, or the like that are used.

In particular, the resin foam of the present invention is preferably formed by passing through a step of pressure reduction after impregnation of high pressure gas (in particular, an inert gas) into the resin composition that at least includes an aliphatic composition and nucleating agent in addition to a thermoplastic resin. In this manner, formation is facilitated of a resin foam that exhibits superior processing characteristics, superior strain recovery characteristics when under pressure, has a cell structure that is resistant to deformation or compression, exhibits superior flexibility, has a high foaming factor, has a cell structure having a low closed-cell structure ratio, and has a small average cell diameter.

The resin foam of the present invention is preferably formed by passing through a step of pressure reduction after impregnation of an inert gas in a supercritical state into the resin composition that at least includes an aliphatic composition and a nucleating agent that has a particularly small average particle diameter, in addition to a thermoplastic resin. In this manner, formation is facilitated of a resin foam that exhibits superior processing characteristics, is more resistant to the nucleating agent piercing the cell wall, exhibits superior strain recovery characteristics when under pressure, has a cell structure that is resistant to deformation or compression, exhibits superior flexibility, has a high foaming factor, has a cell structure having a low closed-cell structure ratio, and has an extremely small average cell diameter.

The resin foam of the present invention is preferably formed by passing through a step of pressure reduction after impregnation of a high pressure gas (in particular, an inert gas) into the resin composition that at least includes 1 to 5 parts by weight of an aliphatic composition relative to 100 parts by weight of a thermoplastic resin, and 0.5 to 150 parts by weight of a nucleating agent relative to 100 parts by weight of a thermoplastic resin, in addition to a thermoplastic resin (a thermoplastic resin in 70/30 to 30/70 on a weight basis) that includes a mixture of a thermoplastic resin and a rubber component and/or a thermoplastic elastomer component.

The resin foam of the present invention as described above is preferably manufactured by obtaining a foam by foaming or molding of a resin composition, and then forming or co-extruding a surface layer or a surface with the surface coverage rate specified above onto the foam.

There is no particular limitation in relation to the method of forming the specific surface or surface layer, and for example it can include hot melt processing, resin coating, solvent welding of the resin layer, adhesion of a resin film layer though an adhesive layer, co-extrusion, or the like. Of such methods, a method that enables a configuration of the same composition in the thickness direction of the resin foam is preferred, and more specifically a method of hot melt processing is more preferred in light of the lack of a requirement to consider compatibility with other materials and the low change in the thickness.

The hot melt processing for example includes press processing using a hot roller, laser irradiation processing, contact melting on a heated roller, flame processing or the like.

When applying press processing using a hot roller, a process can be used that incorporates a hot laminator, or the like. The material of the roller includes rubber, metal, a fluorine-based resin (for example, Teflon (Registered Trademark)), or the like.

In view of the efficient formation of a specific surface or a surface layer, the temperature of the hot melt processing is preferably at least a temperature that is 15 degrees C. lower than the softening point or the melting point of the resin that configures the resin foam (more preferably, a temperature that is 12 degrees C. lower), or a temperature that is no more than 20 degrees C. higher than the softening point or melting point of the resin that configures the resin foam (more preferably, a temperature 10 degrees C. higher). In this manner, the melting of the foam surface proceeds in a suitable manner, the specific surface or surface layer is obtained, contraction or the like of the foam structure does not occur, and creasing or the like can be prevented.

Depending on the processing temperature, the processing period for hot melt processing is preferably about 0.1 to 10 seconds, and more preferably about 0.5 to 7 seconds. When in this time range, the melting of foam structure proceeds in a suitable manner, the specific surface layer is obtained, contraction or the like of the foam structure does not occur, and creasing or the like can be prevented.

During adhesion of the resin film layer by way of an adhesive layer, solvent welding of the resin layer, or resin coating, the resin composition used in formation of the foam is suitably applied in light of operation characteristics or to facilitate forming the same composite.

There is no particular limitation on the thickness and shape of the resin foam of the present invention, and it can be suitably adjusted in response to the uses described below. Furthermore, the manufactured resin foam can be processed to a suitable shape and thickness in response to the uses described below.

Foam Material

The foam material of the present invention is a material that includes the resin foam described above. There is no particular limitation in relation to the shape of the foam material, and it is preferably has a sheet shape (including a film shape). The foam material for example can be configured only from a resin foam, or have a configuration in which an adhesive layer, substrate layer, or the like are laminated onto the resin foam.

In particular, the foam material of the present invention preferably includes an adhesive layer. For example, when the foam material of the present invention is a sheet-shaped foam material, the adhesive layer can be provided on one or both surfaces thereof. When the foam material has an adhesive layer, for example, a processing mount can be provided via the adhesive layer onto the foam material, and then fixed or prefixed to an adherend.

An adhesive for constituting the adhesive layer is not limited and can be suitably chosen from among known adhesives such as acrylic adhesives, rubber adhesives (e.g., natural rubber adhesives and synthetic rubber adhesives), silicone adhesives, polyester adhesives, urethane adhesives, polyamide adhesives, epoxy adhesives, vinyl alkyl ether adhesives, and fluorine-containing adhesives. The adhesives can be used alone or in combination of two or more. The adhesives can be adhesives of any type, such as emulsion adhesives, solvent adhesives, hot-melt adhesives, oligomer adhesives, and solid adhesives. Of such adhesives, acrylic adhesives are preferred from the viewpoint typically of preventing contamination to the adherend.

The adhesive layer has a thickness of from 2 to 100 micrometer, and preferably from 10 to 100 micrometer. The thickness of the adhesive layer is preferably minimized, because such a thin adhesive layer can be more effectively prevented from the attachment of dirt or dust at the edges thereof.

The adhesive layer can have a single-layer structure or multilayer structure, and a foaming layer or non-foaming layer. Of these, the adhesive layer is preferably a non-foaming adhesive layer.

The adhesive layer in the foam material of the present invention can be provided by way of another layer (lower layer). The lower layer includes for example another adhesive layer, an intermediate layer, a primer layer, a substrate layer (in particular, a film layer, non-woven material layer, or the like), or the like. The lower layer can be a foam layer, or a porous layer, and is preferably a non-foam layer, and more preferably resin layer.

The adhesive layer can be protected by a peelable film (separator) (for example, peelable paper, peelable film, or the like).

The foam material of the present invention includes the resin foam of the present invention, and therefore exhibits improved dust resistance characteristics, and in particular, dynamic dust resistance characteristics. In addition, trackable flexibility is exhibited in relation to microscope clearances, and improved light shielding characteristics can be imparted.

The foam material of the present invention for example is preferably processed to exhibit various thicknesses and shapes corresponding to the device, instrument, housing, member, or the like to which it is to be applied.

The foam material of the present invention is used as a member used when mounting (attaching) various members or components, for example, components that configure an electrical or electronic device, and for example can be applied as a dust preventing member, sealing member, impact absorption member, sound insulating member, cushioning material, or the like. The components that configure an electrical or electronic device more specifically include an image display member (display unit) (in particular a small image display unit) that is mounted on an image display device such as a liquid crystal display, an electroluminescence display, a plasma display, or the like, and include an optical member or an optical component such as a lens and camera (in particular a small camera or lens) that is mounted to a device configured for mobile communication such as, so-called, a “mobile telephone”, “mobile information terminal”, or the like.

A suitable configuration for use of the foam material of the present invention, for example, includes a component used by insertion between a display unit and housing (window) of a liquid crystal display (LCD), at a display unit peripheral such as a liquid crystal display (LCD) for the purpose of preventing dust, shielding light, damping, or the like.

The foam material of the present invention, when mounted on this type of member or component, preferably is mounted to cover a clearance of the member or component. There is no particular limitation for the clearance that for example can be about 0.05 to 0.5 mm.

The foam material and resin foam of the present invention will be described below making reference to the examples.

### Example 1

As the resin composition,

35 parts by weight of polypropylene (melt flow rate (MFR): 0.35 g/10 min),

60 parts by weight of a thermoplastic elastomer composition (a blend of polypropylene (PP) and ethylene/propylene/5-ethylidene-2-norbornene terpolymer (EPT) (crosslinked olefin thermoplastic elastomer, TPV), the ratio of the polypropylene and ethylene/propylene/5-ethylidene-2-norbornene terpolymer is 25/75, and including 15 wt % of carbon black),

3.8 parts by weight of a lubricant (master batch blending 10 parts by weight of polyethylene in 1 part by weight of stearic acid monoglyceride),

10 parts by weight of a nucleating agent (magnesium hydroxide, average particle diameter: 0.8 micrometers), and

2 parts by weight of erucic acid amide (melting point 80 to 85 degrees C.) were kneaded at a temperature of 200 degrees C. using twin screw kneader.

Thereafter, the resin component was extruded into a strand shape, cooled with water and cut into pellets for molding.

The pellets were placed into a tandem-type single-screw extruder manufactured by Japan Steel Works LTD., and carbon dioxide gas was introduced under a pressure of 17 (after introduction 13) MPa in an atmosphere at 240 degrees C. The carbon dioxide gas was introduced at a ratio of 5 wt % in relative to the total polymer amount. The carbon dioxide gas was allowed sufficiently to saturate and to cool to a temperature at which the gas was suitable for foaming operations. Then, extrusion was performed from a die, and the ratio of the resin extrusion speed and the molding speed was adjusted to be in the range of 1:1.2 to 2 to thereby obtain a resin foam (in a sheet shape), thereby to obtain a resin foam in the form of semiclosed- and semiopen-cell structure. The resin foam had semiclosed- and semiopen-cell structure having 32% of closed cell. The resin foam was sliced to obtain a resin foam A having a thickness of 1.1 mm.

The surface of the resulting resin foam A was hot melt processed under conditions of roller temperature of 170 degrees C., processing speed of 12 m/min using a dielectric hot roller manufactured by Tokuden Co., Ltd to form a surface layer having a thickness of 0.12 mm on the surface. The average cell diameter was 85 micrometers.

### Example 2

With the exception that hot melt processing of the surface of the resulting resin foam A was performed at a roller temperature of 165 degrees C., hot melt processing was performed in the same manner as Example 1. The thickness of the resulting surface layer was 0.10 mm. The average cell diameter was 85 micrometers.

### Example 3

With the exception that hot melt processing of the surface of the resulting resin foam A was performed at a roller temperature of 160 degrees C., hot melt processing was performed in the same manner as Example 1. The thickness of the resulting surface layer was 0.08 mm. The average cell diameter was 85 micrometers.

### Comparative Example 1

The surface of the resulting resin foam A was not subjected to hot melt processing. The average cell diameter was 80 micrometers.

### Comparative Example 2

The resin composition including:

45 parts by weight of polypropylene,

55 parts by weight of a thermoplastic elastomer composition

10 parts by weight of a lubricant, and

10 parts by weight of a nucleating agent were kneaded at a temperature of 200 degrees C. using twin screw kneader.

The thermoplastic elastomer composition includes 15 wt % of carbon black, and was a blend of polypropylene (PP) and ethylene/propylene/5-ethylidene-2-norbornene terpolymer (EPT), the ratio of the polypropylene and ethylene/propylene/5-ethylidene-2-norbornene terpolymer was 30/70 (by weight). The same polypropylene, lubricant, and nucleating agent as those in Example 1 were used.

Thereafter, the resin component was extruded into a strand shape, cooled with water and molded into pellets.

The pellets were placed into a tandem-type single-screw extruder manufactured by Japan Steel Works LTD., and 3.8 wt % of carbon dioxide gas was introduced under a pressure of 14 (after introduction 18) MPa in an atmosphere at 220 degrees C. After the carbon dioxide gas was sufficiently saturated, cooling was performed to a temperature suitable for foaming operations, and then, extrusion was performed from a die to thereby obtain a resin foam (in a sheet shape). The resin foam was sliced to obtain a resin foam B having a thickness of 1.1 mm. The average cell diameter was 80 micrometers.

### Comparative Example 3

The foam structure B was hot melt processed to form a surface layer under conditions of roller temperature of 160 degrees C., processing rate of 12 m/min using a dielectric hot roller manufactured by Tokuden Co., Ltd. The thickness of the resulting surface layer was 0.1 mm. The average cell diameter was 83 micrometers.

### Comparative Example 4

A foam having a principal component of polyurethane and having a black PET layer laminated onto one surface was prepared. The average cell diameter was 80 micrometers.

### Method of Measurement Closed Cell Ratio

The closed cell ratio of the resin foam obtained in the examples and the comparative examples was measured using the method below.

A test piece in a planar square shape having a predetermined thickness and sides of 5 cm was cut from the resulting resin foam. Then, the weight W1 (g) and the thickness (cm) of the test piece were measured, to thereby calculate the apparent volume V1 (cm³) of the test piece.

Next, those values were substituted into Equation (1) to calculate the apparent volume V2 (cm³) occupied by the cells. The density of the resin that configures the test piece was expressed as ρ g/cm³.

Apparent volume occupied by the cells V2=V1−W1/ρ (1)

Then, the test piece was immersed in distilled water at 23 degrees C. so that the distance from the upper surface of the test piece to the water surface was 40 mm, and left for 24 hours. Thereafter, the test piece was taken from the distilled water, and moisture attached to the surface of the test piece was removed. The weight W2 (g) of the resulting test piece was measured to calculate the open cell ratio F1 based on Equation (2). The closed cell ratio F2 was calculated using the open cell ratio F1.

Open cell ratio F1=100×(W2−W1)/V2 (2)

Closed cell ratio F1=100−F1 (3)

### Method of Measurement of Average Cell Diameter

A smooth cross sectional surface was prepared by cutting with a cutter in a direction perpendicular (thickness direction) to the main surface of the resin foam to be parallel to the direction orthogonal to the MD direction (flow direction) of the resin foam. These cross sectional surfaces were captured as an enlarged image of the cells of the resin foam using a digital microscope (Trade name “VHX-500” manufactured by Keyence Corporation), and the average cell diameter (micrometers) was calculated by image analysis using analysis software for that measurement device (Win ROOF manufactured by Mitani Co., Ltd.). The number of cells in the captured enlarged image was about 200, and this value of 200 was taken as the average.

### Evaluation

The sheets of the resin foams obtained in the examples and the comparative example were measured and evaluated in relation to apparent density, a repulsive force at an 80% compression, surface coverage rate, thickness recovery rate, transmittance of light at 550 nm, and dust resistance characteristics, respectively. The results were illustrated in Table 1.

### Method of Measuring Apparent Density

The resin foam obtained in the examples and the comparative example was configured as a test piece by punching into dimensions of 20 mm×20 mm, and the dimensions of the test piece were measured using calipers. Furthermore, the mass of the resin foams was measured using scales. These values were used to calculate an apparent density for the resin foams in portions other than the surface layer.

Apparent density (g/cm³)=mass test piece/volume test piece

### Method of Measurement of Repulsive Force During 80% Compression

Measurements were performed using a compression hardness method that complies with JIS K 6767.

The resin foam was cut out into width of 30 mm×length of 30 mm and configured as a sheet-shaped test piece. Next the test piece was compressed at 23 degrees C. at a compression speed of 10 mm/min in a thickness direction to a compression rate of 80%, and the resulting stress (N) was converted to unit surface area (1 cm²) to thereby obtain a repulsive force (N/cm²).

### Method of Measuring Surface Coverage Rate

An enlarged image of the cell portion of the foam was captured using a digital microscope (Trade name “VHX-500” manufactured by Keyence Corporation), and the surface area (micrometers) of pores present in the surface and the surface area of the surface of the resin foam was calculated by image analysis using analysis software for that measurement device to thereby calculate the surface coverage rate from Equation (1).

### Method of Measuring Thickness Recovery Rate

The resin foam was compressed in an atmosphere at 23 degrees C. in the thickness direction using an electromagnetic-type micro test device (micro-servo “MMT-250” manufactured by Shimadzu Corporation) to a 20% thickness relative to the initial thickness and maintained in a compressed state for one minute. After release of the compression, thickness recovery behavior (recovery of thickness or thickness deformation) was imaged using a high speed camera to thereby calculate the thickness one second after releasing the compressed state from the captured image. The instantaneous recovery rate was thereby calculated using the following equation.

Instantaneous recovery rate (%)=(thickness one second after release of compressed state)/(initial thickness)×100

### Method of Measurement of Transmittance

The calculation was performed in relation to light at a wavelength of 550 nm that was illuminated from one side surface of the resin foam, the intensity of the light transmitted to the other side surface was measured using a “U-4100 spectrophotometer” manufactured by Hitachi High-Technologies Corporation.

### Method of Measuring Dust Resistance Characteristics

The measurement of dust resistance characteristics of the resin foam was performed in accordance with the measurement method using an evaluation container for dynamic dust resistance characteristics as disclosed in Japanese Patent Application Laid-Open No. 2011-162717.

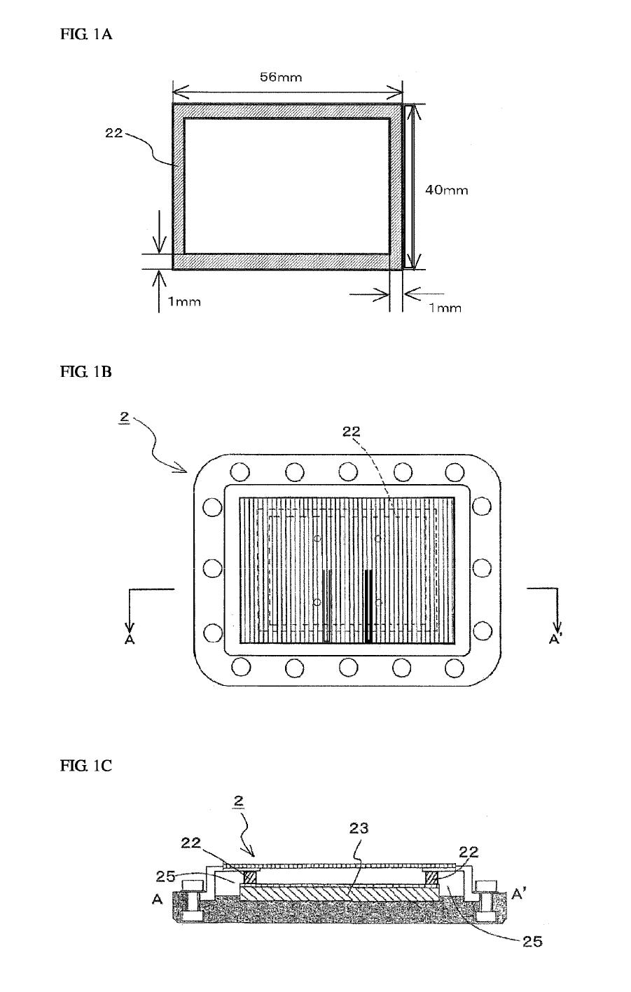

That is to say, as illustrated in FIG. 1A, the resin foam obtained in the examples and the comparative examples was punched into a picture frame shape (window-frame shape) (width 1 mm) to thereby prepare evaluation sample 22. A peelable liner was removed from all evaluation sample 22.

The evaluation sample 22 was attached to the evaluation container 2 as illustrated in FIG. 1B and FIG. 1C and subjected to a compression ratio of 20% (compressed to 80% of the initial thickness).

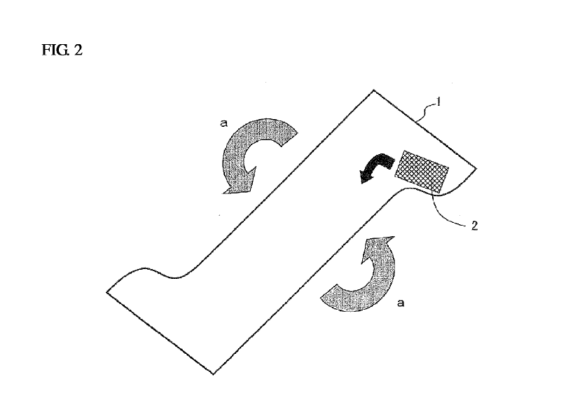

The compression ratio was adjusted using an aluminum spacer 23. An amount of 0.1 g of corn starch (particle diameter: 17 micrometers) was introduced as particulate matter into a powder supply unit 25 that was provided in the evaluation container 2, the evaluation container 2 was placed into a drum-type test device (rotating-type drop apparatus) 1 as illustrated in FIG. 2 and rotated as a speed of 1 rpm.

The container 2 was rotated for a predetermined number of rotations so that 100 impacts (repetitive collisions) were obtained in the evaluation device 2. Thereafter, the evaluation container 2 was disassembled, and the powder that has entered from the powder supply unit 25 through the evaluation sample 22 into an inner portion of the evaluation container 2 was observed using a microscope (Trade name “VHX-500” manufactured by Keyence Corporation). The number of particles was counted using image analysis software. This observation was performed in a clean chamber in order to reduce any effect of free particulate matter in the air.

TABLE 1

| | Examples | | | Comparative Examples | | | |
|---|---|---|---|---|---|---|---|
| | 1 | 2 | 3 | 1 | 2 | 3 | 4 |
| Apparent Density (g/cm³) | 0.080 | 0.075 | 0.071 | 0.065 | 0.050 | 0.075 | 0.15 |
| Repulsive Force during 80% | 4.5 | 4.1 | 4.0 | 3.9 | 4.5 | 5.0 | 10.5 |
| Compression (N/cm²) | | | | | | | |
| Surface Coverage Rate (%) | 88.9 | 83.7 | 75.4 | 30.1 | 24.3 | 80.0 | 100 |
| Thickness Recovery Rate | 76 | 78 | 78 | 79 | 48 | 35 | 58 |
| (%) | | | | | | | |
| Transmittance (%) (550 nm) | 0.0081 | 0.0085 | 0.0070 | 0.093 | 0.086 | 0.0076 | 0.0076 |
| Dust Resistance | 5.5 | 5.0 | 5.2 | 8.0 | 14 | 12 | 11 |
| Characteristics (×10⁵) | | | | | | | |

According to Table 1, the resin foam of the examples is confirmed to exhibit flexibility and superior light shielding characteristics and dust resistance characteristics.

### INDUSTRIAL APPLICABILITY

The present invention is a resin foam and a foam material that exhibit a high expansion rate and superior strain recovery characteristics and cushioning characteristics, and that are useful in relation to internal insulation of electronic equipment and the like, damping materials, sound insulation materials, dust-proofing materials, shock absorbing materials, light shielding materials, and insulating materials, food packaging materials, clothing materials, building materials, or the like. In particular, the present invention finds wide application in display unit peripherals such as mobile telephones, mobile information terminals, LCDs or the like, and more specifically, as various members positioned between the LCD and the housing (window).

### REFERENCE SIGNS LIST

1 drum-type drop test device
2 evaluation container for dynamic dust resistance characteristics
22 evaluation samples
23 aluminum spacer
25 external space

1.-11. (canceled)

12. A resin foam having
a repulsive force during an 80% compression at 23 degrees C. of 0.1 to 5.0 N/cm²,
a surface coverage rate of a foam surface of at least 50%, and
a thickness recovery rate as defined below of at least 50%,
the thickness recovery rate is defined as the ratio to an initial thickness of a thickness one second after release of a compressed state that is obtained by releasing a compressed state after compressing resin foam for one minute to a thickness of 20% relative to the initial thickness.

13. The resin foam according to claim 12, wherein
the resin foam has an apparent density of from 0.01 to 0.20 g/cm³.

14. The resin foam according to claim 12, wherein
the resin that configures the resin is a thermoplastic resin.

15. The resin foam according to claim 12 that is a foamed resin under pressure reduction process of a thermoplastic resin composition impregnated high pressure gas.

16. The resin foam according to claim 15, wherein
the gas is an inert gas.

17. The resin foam according to claim 16, wherein
the inert gas is carbon dioxide or nitrogen.

18. The resin foam according to claim 15, wherein
the gas is a gas in a supercritical state.

19. A foamed material comprising the resin foam according to claim 12.

20. The foamed material according to claim 19, comprising an adhesive layer disposed on one or both sides of the resin foam.

21. The foamed material according to claim 19, wherein
the adhesive layer is formed from an acrylic adhesive.

22. The foamed material according to claim 19 for use in relation to an electronic or electrical device.
